(19) United States
(12) Patent Application Publication
(10) Pub. No.: US 2011/0137994 A1
(43) Pub. Date: Jun. 9, 2011

(54) SYSTEM AND METHOD OF A PURCHASING INFORMATION PLATFORM

(76) Inventors: Ashvin A. Kumar, Los Altos Hills, CA (US); Christopher T. Estreich, Sebastopol, CA (US)

(21) Appl. No.: 12/964,001

(22) Filed: Dec. 9, 2010

Related U.S. Application Data
(60) Provisional application No. 61/285,059, filed on Dec. 9, 2009.

(51) Int. Cl. G06F 15/16

(52) U.S. Cl. 709/204

(57) ABSTRACT

In embodiments of the present invention improved capabilities are described for facilitating sharing of user-submitted purchase information with other users of a social network. A purchasing information platform may secure permission from the user to connect to a user account, passively gather user purchasing information from the user account, provide a user-search facility to allow the user to find another user within the social network, allow the user to create a sharing user by selecting another user to share the user purchasing information with, publish the user purchasing information so that it becomes viewable to the sharing user, and allow the user and the sharing user to create commentary on the published user purchasing information. Related user interfaces, application programming interfaces, applications, and systems are disclosed.

### CROSS-REFERENCE TO RELATED APPLICATIONS

This application claims the benefit of the following provisional applications, each of which is hereby incorporated by reference in its entirety:

U.S. Application No. 61/285,059, filed Dec. 9, 2009.

### BACKGROUND

1. Field:

This invention relates to the field of social networking with respect to purchasing information.

2. Description of the Related Art

Social networking platforms may not currently provide users the ability to share purchase information with other users.

There remains a need for a platform that enables social networking with respect to purchasing information.

### SUMMARY

Disclosure herein relates to a purchasing information platform and associated methods thereof. In an aspect of the invention, a computer-readable storage medium with an executable program stored thereon for facilitating sharing of user-submitted purchase information with other users of a social network may instruct a processor to perform the following steps: securing permission from the user to connect to a user account, passively gathering user purchasing information from the user account, providing a user-search facility to allow the user to find another user within the social network, allowing the user to create a sharing user by selecting another user to share the user purchasing information with, publishing the user purchasing information so that it becomes viewable to the sharing user, by a group of users, or by anyone on the system, and allowing the user and the sharing user to create commentary on the published user purchasing information. The user account may include at least one of a credit card account, a bank account, a financial account, a music purchasing account, a movie rental account, an online retail account, a mobile purchase account, an online purchase account, a loyalty card, a library borrowing account, a toll transponder account, and a gym attendance record. The purchasing information may also be viewable by a group of users of the social network. The purchasing information may be viewable by all users of the social network.

In an aspect of the invention, a purchasing information platform may be implemented in a computer system with a memory that aggregates user purchasing information for at least one user of a social network. The purchasing information platform may include a security facility that secures permission from the user to connect to a user account, a data processor that passively gathers user purchasing information from the user account, a database that stores user purchasing information from the user account gathered by the data processor, a user-search facility that allows the user to find another user within the social network and create a sharing user by selecting another user to share the user purchasing information with, and a publishing facility that publishes the user purchasing information so that it becomes viewable to the sharing user and allows at least one of the user and the sharing user to create commentary on the published user purchasing information. The purchasing information platform may further include an analysis processor that aggregates and analyzes the user purchasing information stored in the database. The purchasing information platform may further include a publicly accessible API allowing the development of applications based on the aggregated and non-aggregated user purchasing data. The analysis processor may aggregate the user purchasing information by at least one of product purchased, purchase type, purchase location, purchase price, retailer type, user, and user location.

In an aspect of the invention, facilitating sharing of user-submitted purchase information with other users of a social network may include securing permission from the user to connect to a user email account, passively gathering user purchasing information from the user email account, providing a user-search facility to allow the user to find another user within the social network, allowing the user to create a sharing user by selecting another user to share the user purchasing information with, publishing the user purchasing information so that it becomes viewable to the sharing user, and allowing the user and the sharing user to create commentary on the published user purchasing information. The purchasing information may also be viewable by a group of users of the social network. The purchasing information may be viewable by all users of the social network.

In an aspect of the invention, a method may include representing product purchase data as a product graph data structure having vertices and edges, wherein each input field of the data structure is defined as a vertex in the graph and each link between input fields is defined as an edge between the vertices to form the graph; and interpreting the relationship between the edges and vertices of the product graph data structure to obtain a result.

These and other systems, methods, objects, features, and advantages of the present invention will be apparent to those skilled in the art from the following detailed description of the preferred embodiment and the drawings. All documents mentioned herein are hereby incorporated in their entirety by reference.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a block diagram of a purchasing information platform.

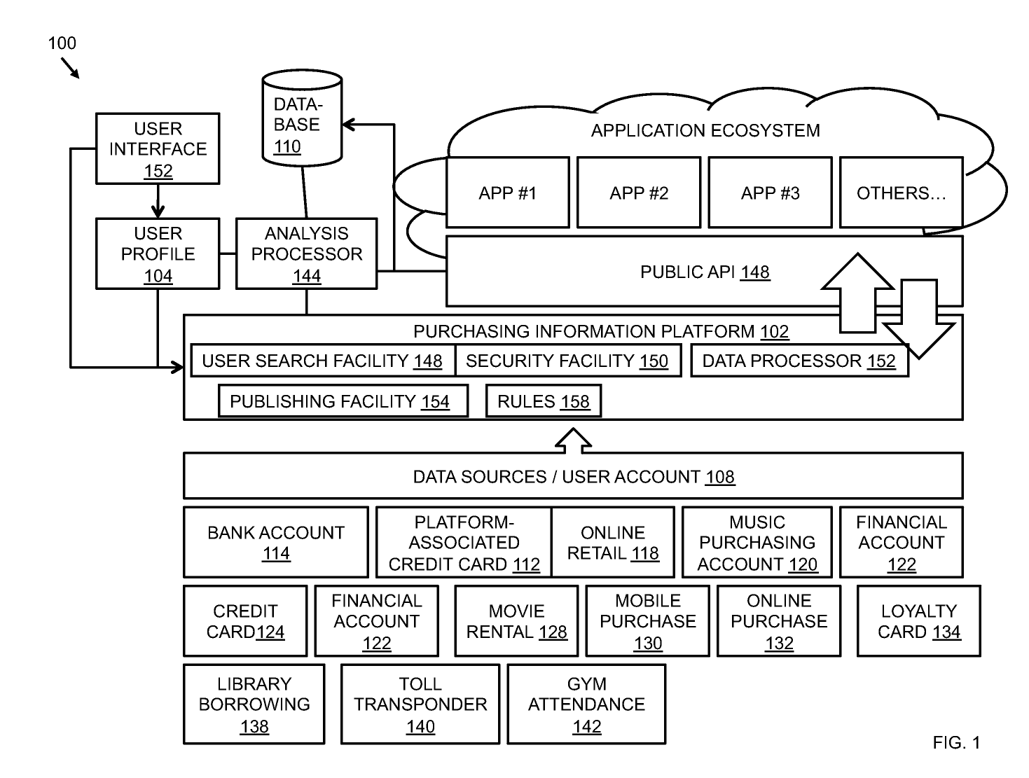

FIG. 2 depicts a flowchart for a method of a purchasing information platform.

### DETAILED DESCRIPTION

A social network may be built around the sharing of user-submitted structured, financial data on a purchasing information platform 102. Users may allow the platform 102 to pull their purchase data from various data sources, accounts and loyalty cards in order to share the purchase data with other users of the platform 102. For example, a web site associated with a user, hereinafter known as the user profile 104, may publish information regarding a purchase. Other users who have been given access to the user profile 104, hereinafter known as sharing users, may be able to view the purchase information, comment on the information, share the information with additional users, and the like. In embodiments, users may also manually post content to their user profiles 104 that may be available for viewing by sharing users. In an embodiment, purchasing information may be viewed on a dedicated web site or may be republished to other social networks, such as FACEBOOK, TWITTER, and the like.

The purchasing information platform 102 may be implemented in a computer system with a memory that aggregates user purchasing information for at least one user of a social network. A user of the platform 102 may give the platform 102 permission to connect to one or more user accounts 108. For example, the user may be prompted by the platform 102 to enter their user account 108 access information into a user interface of the platform 102, wherein the user account 108 is a purchase account, email account, and the like. The platform 102 may securely store the access information so that it can pull, or automatically and passively gather, purchase account information from the user account periodically, on a schedule, as directed, or on demand. Users may be constantly sharing purchasing information without direct interaction with the platform 102. The user purchasing information may be stored in a database 110 of the platform 102. In the example where the user account 108 is an email account, receipts in emails may be searched and parsed to find purchases, transactions and products purchased.

In an aspect of the invention, passive data publishing and sharing may be enabled by a physical device, such as a platform-associated credit card 112.

In an embodiment, the user purchasing information may be public, semi-public, or private. When a user signs up with the purchasing information platform, the user may provide purchasing information access information to the platform. For example, the user may provide log-in information for at least one user account 108, such as a purchase account, an email account, a financial account 122, a credit card 124, a bank account 114, a music purchasing account 120, a movie rental account 128, an online retail account 118, a mobile purchase account 130, an online purchase account 132, a loyalty card 134, a library borrowing account 138, a toll transponder account 140, a gym attendance record 142, and the like. In an embodiment, the purchasing information may be cash purchase data acquired through a loyalty card record.

The purchasing information may be structured data enabling an analysis processor 144 of the platform 102 to aggregate and analyze the purchase information stored in the database. For data that are not structured, the analysis processor 144 may employ methods to manipulate the data into a format accessible by the database 110, platform 102, API 148, and the like. The analysis processor 144 may aggregate the user purchasing information by product purchased, purchase type, purchase location, purchase price, retailer/merchant type, retailer/merchant location, user, user location, and the like. In an embodiment, an API 148 associated with the platform 102 may access the aggregated data as part of an application. The analysis processor 144 may be used by the API 148 in further analyzing the aggregated data. Non-aggregated purchasing information or data, such as individual data, may also be accessible and available via the API 148. Purchasing information and data might identify the specific user, if he gives such permission, or might not contain any identifying information. The API 148 may also allow for bi-directional communication back to the users, whether or not the purchasing information used by the API contains identifying information. For example, users of the API may collect purchasing information, but they may also inject information to the platform 102, such as automated comments on certain transactions, special offers, and the like.

Users of the platform 102 may select other users of the platform 102 with whom to share their purchase information. The user may employ a user-search facility 148 of the platform 102 in order to find another user within the social network. For example, the user may be able to search by a name, an email address, an affiliation, a demographic information, and the like. When the user identifies another user they would like to share their purchasing information with, they may connect with the user on the platform 102, either automatically or by request. When the users connect, they become sharing users to one another. In an embodiment, all of a user's purchase information may be shared with their sharing users. In other embodiments, the user may select only certain sharing users with whom to share certain purchasing information. For example, the user may allow all sharing users to view purchases made with a music purchase account but may select a subset of sharing users to view purchases made with a credit card. A security facility 150 of the platform 102 may be used to manage setting the subset communities of sharing users.

In embodiments, users may be able to select certain types of purchasing information to share while excluding others. A rules server 158 of the platform 102 may be used to set rules regarding the type of purchasing information to be shared.

In an embodiment, user purchasing information may be published so that it becomes viewable to a sharing user. For example, the user may be using their credit card to make purchases at various stores, using their music purchase account to purchase music online, using a movie rental account to rent a DVD, and the like. If the user has given the platform 102 permission to connect to these accounts, the purchasing information from the accounts may be accessed by the platform 102 and the purchasing information may be stored in a database 110 of the platform 102. The purchasing information may then be published by the platform 102 and accessible by a user interface 152 of the platform 102 viewing the user profile 104. In embodiments, the purchasing information may also be viewable on a web site, such as a home page, that aggregates purchasing information for all of a user's sharing users. When purchasing information is published, a notification may be sent to at least one of the user, a sharing user, a group of users, or by anyone using the platform 102.

In an embodiment, publishing the purchasing information may include publishing a picture of the product, a link to a review of the product, a link to a source selling the product, a rating, other users and/or sharing users who have made a similar purchase, and the like.

In an embodiment, each purchase may appear as a single entry on the user profile 104 or home page. In embodiments, multiple purchases may be grouped by day, type, currency used, amount spent, and the like. In an embodiment, even if the user had previously indicated that a certain purchase or class of purchases should only be accessible by a certain sharing users, the user may override the preference and choose to share it with other sharing users, no sharing users at all, and the like.

In an embodiment, users and sharing users may interact around the purchasing information. For example, users and sharing users may create commentary on the published user purchasing information. Other actions associated with the purchasing information may also be possible. For example, the user or sharing user may add additional information to the purchasing information, such as by adding a picture of the product, a link to a review of the product, a link to a source selling the product, a rating, and the like. In another example, the sharing user may share the purchase information with their sharing users, who may or may not be sharing users of the user who published the purchasing information. When an interaction related to the purchasing information is made, a notification may be sent to at least one of the user and sharing user.

Social networking in relation to user purchasing information may allow users to discover new products, great deals, the existence of a retailer, and the like. The user purchasing information may reveal social information about the user that may enable further networking. For example, a purchase at a florist, a chocolate shop, and a French bistro may reveal that the user is dating someone. The user purchasing information may reveal experts and mavens and may enable crowd intelligence with regard to a subject highlighted or initiated by the purchasing information. For example, purchasing supplies for a given type of work, such as a mechanical red pencil typically used by design engineers, may let sharing users know that the user is a design engineer. In another example, purchasing information may spark a dialogue with the user about their research into making the purchase.

In an embodiment, social networking in relation to user purchasing information may reveal variable pricing for a product and may expose scams. For example, a sharing user may see that a user paid $100 for a television where they paid $150. The sharing user may then be able to research ways to go about receiving a price adjustment based on this acquired knowledge.

In an embodiment, social networking in relation to user purchasing information may enable group purchasing. For example, users may manually post content to their user profiles relating to an intended purchase, ongoing promotion, invitation for a group purchase, and the like. Sharing users may view the post and comment, participate in the group purchase, and the like.

In an embodiment, social networking in relation to user purchasing information may enable corporate expense reporting. Sharing purchasing information around submitted data may ensure accuracy in reporting, similar treatment for similar expenses, and the like. Corporate costs may be lowered through the transparency of public sharing of data.

In an embodiment, users may receive highly targeted advertising and promotions as a result of sharing purchasing information. For example, if a user publishes purchasing information related to a sleeping bag purchase, a retailer associated with the platform may target the user for advertising related to camping gear. The advertising may be delivered on the user profile 104, on the home page, via email, and the like. Users may have to opt-in to be contacted by merchants where they spend money, and/or other advertisers based on personal data they share. Offline businesses with no means of communicating with their customers, let alone knowing their best customers may use the platform 102 to track their best customers and be able to communicate with them. Businesses may contact users through the platform 102 without knowing their identity.

In an embodiment, the platform 102 may be an open platform 102 for developing applications based on aggregation and analysis of data related to transactions and individual product purchases to reveal information about products and the people who purchase or consume them. In effect, the platform 102 may be a product graph, enabling a rich set of applications/embodiments to be built based on the information about the products people are purchasing/consuming. The product graph may contain a plurality of nodes and edges, such as product nodes, user nodes, merchant nodes, manufacturer nodes, category edges, user relationship edges, product relationship edges, and the like. Attributes of the product graph may be related to product similarity, product distribution, product reviews, transaction times, transaction frequency, purchase price, user relationships, user purchases, and the like. In an embodiment, a visualization of the product graph may be navigated using a GUI.

An API 148 of the platform 102 may access data aggregated by an analysis processor 144 of the platform 102 or non-aggregated data. The analysis processor 144 may be used by the API 148 to further analyze the aggregated and non-aggregated data for use by an application and for bi-directional communication back into the platform 102, as described above. In an embodiment, an application may be directed to budgeting and money management, product reviews, product experience sharing, customer loyalty, transparent auditing and accounting, real-time consumer trends, fraud detection, coordinated purchasing, music purchasing, large life event purchasing, book purchasing, restaurant purchasing, and the like. The product graph may yield a wide range of applications and embodiments in an application ecosystem that may built on it. For example, a user may be able to use an application to generate a presentation or report based on the purchasing information aggregated by the platform 102. In another example, a user may be able to generate a map of where purchases were made based on the purchasing information. In another embodiment, an application may be directed at purchasing information for a single type of product or item.

In an embodiment, an application may be a product review application. In the application, users can request product reviews of one another after identifying that they have purchased or will purchase a particular item. Users may be able to ask specific questions and receive answers about products from various users of the platform 102.

Data related to the product graph may be accessed using a filter. For example, filters could be used at particular nodes or edges, groups of nodes or edges, or the like, to obtain data. For example, a filter may be used to determine how many products or referrals a person makes, who buys the product based on their reviews, similar products, and the like.

In an embodiment, an application may be a loyalty program. The purchasing information may be used in an automatic loyalty program. For example, based on purchasing information, Goat Hill Pizza may know that a user has been there 3 times. The user may be only 7 visits away from a free pizza. Notification of this may be through the platform 102. Merchants/retailers could have a sticker/sign encouraging people to sign up for the automatic loyalty program on the platform 102. The advantage over loyalty punch cards is that transactions shared on the platform 102 are tied to online identity, so merchants/retailers can communicate with customers outside the store to let them know about specials, promotions, and the like. Additionally, the more customers of a merchant/retailer sharing their purchasing information, the more other users will notice it, and subsequently, the merchant/retailer may benefit from the exposure.

In an embodiment, an application may be directed at retail intelligence. By accessing purchasing information, any retailer can learn about their audience and buying patterns. In embodiments, retailers may learn about the audience and buying patterns of other retailers' customers.

In an embodiment, an application may be directed at integration into review sites, such as YELP.COM, CITYSEARCH, TRIPADVISOR, and the like. The review site may be able to display a real-time feed of actual customers for every restaurant and hotel by accessing the purchasing information. Users may be able to ask questions and discuss with each other.

In an embodiment, an application may be directed at integration into feed readers, such as TWEETIE, SEESMIC, BRIZZLY, and the like.

In an embodiment, an application may be directed at a book club application. By sharing purchasing information, users may expose what books they are purchasing or borrowing. People who bought the same book may be identified to one another and may be able to initiate a discussion.

In an embodiment, a purchasing information platform 102 may be implemented in a computer system with a memory that aggregates user purchasing information for at least one user of a social network. The purchasing information platform may include a security facility 150 that secures permission from the user to connect to a user account, a data processor 152 that passively gathers user purchasing information from the user account, a database 110 that stores user purchasing information from the user account gathered by the data processor 152, a user-search facility 148 that allows the user to find another user within the social network and create a sharing user by selecting another user to share the user purchasing information with, and a publishing facility 154 that publishes the user purchasing information so that it becomes viewable to the sharing user and allows at least one of the user and the sharing user to create commentary on the published user purchasing information. The purchasing information platform 102 may further include a publicly accessible API 148 allowing the development of applications based on the aggregated and non-aggregated user purchasing data.

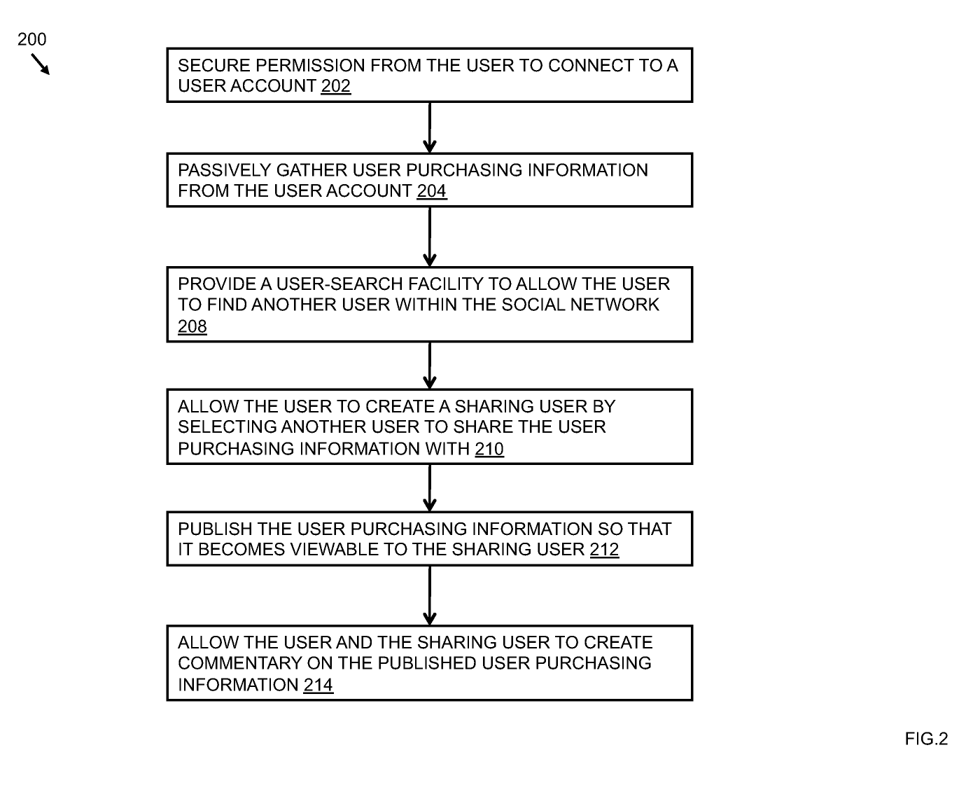

Referring to FIG. 2, a computer-readable storage medium with an executable program stored thereon for facilitating sharing of user-submitted purchase information with other users of a social network may instruct a processor to perform the following steps: securing permission from the user to connect to a user account 202, passively gathering user purchasing information from the user account 204, providing a user-search facility to allow the user to find another user within the social network 208, allowing the user to create a sharing user by selecting another user to share the user purchasing information with 210, publishing the user purchasing information so that it becomes viewable to the sharing user 212, and allowing the user and the sharing user to create commentary on the published user purchasing information 214. The user account may include at least one of a credit card account, a bank account, a financial account, a music purchasing account, a movie rental account, and an online retail account. The purchasing information may also be viewable by a group of users of the social network. The purchasing information may be viewable by all users of the social network. The platform 102 may be accessible using a mobile device, a wireless device, a cell phone, a smart phone, a computer, and the like. For example, the platform may be accessed as a web site on a computer, as an application on a smart phone, and the like.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A computer-readable storage medium with an executable program stored thereon for facilitating sharing of user-submitted purchase information with other users of a social network, wherein the program instructs a processor to perform the following steps:
securing permission from the user to connect to a user account;
passively gathering user purchasing information from the user account;
providing a user-search facility to allow the user to find another user within the social network;
allowing the user to create a sharing user by selecting another user to share the user purchasing information with;
publishing the user purchasing information so that it becomes viewable to the sharing user; and
allowing the user and the sharing user to create commentary on the published user purchasing information.

2. The medium of claim 1, wherein a user financial account comprises at least one of a credit card account, a bank account, a financial account, a music purchasing account, a movie rental account, an online retail account, a mobile purchase account, an online purchase account, a loyalty card, a library borrowing account, a toll transponder account, and a gym attendance record.

3. The medium of claim 1, wherein the purchasing information is also viewable by a group of users of the social network.

4. The medium of claim 1, wherein the purchasing information is viewable by all users of the social network.

5. A purchasing information platform implemented in a computer system with a memory that aggregates user purchasing information for at least one user of a social network, comprising:
a security facility that secures permission from the user to connect to a user account;
a data processor that passively gathers user purchasing information from the user account;
a database that stores user purchasing information from the user account gathered by the data processor;
a user-search facility that allows the user to find another user within the social network and create a sharing user by selecting another user to share the user purchasing information with; and
a publishing facility that publishes the user purchasing information so that it becomes viewable to the sharing user and allows at least one of the user and the sharing user to create commentary on the published user purchasing information.

6. The system of claim 5, wherein the purchasing information platform further comprises an analysis processor that aggregates and analyzes the user purchasing information stored in the database.

7. The system of claim 5, wherein the information platform further comprises a publicly accessible API allowing the development of applications based on the aggregated and non-aggregated user purchasing data.

8. The system of claim 6, wherein the analysis processor aggregates the user purchasing information by at least one of a product purchased, purchase type, a purchase location, a purchase price, a retailer type, a user, and a user location.

9. A computer-readable storage medium with an executable program stored thereon for facilitating sharing of user-submitted purchase information with other users of a social network, wherein the program instructs a processor to perform the following steps:
securing permission from the user to connect to a user email account;
passively gathering user purchasing information from the user email account;
providing a user-search facility to allow the user to find another user within the social network;
allowing the user to create a sharing user by selecting another user to share the user purchasing information with;
publishing the user purchasing information so that it becomes viewable to the sharing user; and
allowing the user and the sharing user to create commentary on the published user purchasing information.

10. The medium of claim 9, wherein the purchasing information is also viewable by a group of users of the social network.

11. The medium of claim 9, wherein the purchasing information is viewable by all users of the social network.

12. A method, comprising:
representing product purchase data as a product graph data structure having vertices and edges, wherein each input field of the data structure is defined as a vertex in the graph and each link between input fields is defined as an edge between the vertices to form the graph; and
interpreting the relationship between the edges and vertices of the product graph data structure to obtain a result.
